(19) United States
(12) Patent Application Publication
(10) Pub. No.: US 2013/0202891 A1
(43) Pub. Date: Aug. 8, 2013

(54) ELASTOMER BINDING MATERIALS MADE WITH NATURAL OIL BASED POLYOLS

(71) Applicants: Verena M.T. Thiede, Muenster (DE); Klaus Haase, Telgte (DE); Gerhard Mueller, Adlington (GB); Giuseppe Vairo, Correggio (IT); Christoph Juris, Hamm (DE); Joerg Arntzen, Ahlen (DE)

(72) Inventors: Verena M.T. Thiede, Muenster (DE); Klaus Haase, Telgte (DE); Gerhard Mueller, Adlington (GB); Giuseppe Vairo, Correggio (IT); Christoph Juris, Hamm (DE); Joerg Arntzen, Ahlen (DE)

(73) Assignee: DOW GLOBAL TECHNOLOGIES LLC, Midland, MI (US)

(21) Appl. No.: 13/634,496

(22) PCT Filed: Mar. 10, 2011
(86) PCT No.: PCT/US11/27906

§ 371 Date: Oct. 19, 2012

Related U.S. Application Data
(60) Provisional application No. 61/313,306, filed on Mar. 12, 2010.

(51) Int. Cl. C09D 175/04

(52) U.S. Cl. CPC C09D 175/04
USPC 428/407; 524/733

(57) ABSTRACT

Embodiments of the invention provide for polyurethane binders or adhesives that result in an increased amount of renewable resources in the final composite products while yet maintaining the quality of the composite products.

### CROSS-REFERENCE TO RELATED APPLICATIONS

This application claims benefit of U.S. Provisional Patent Application Ser. No. 61/313,306, filed Mar. 12, 2010, entitled “ELASTOMER BINDING MATERIALS MADE WITH NATURAL OIL BASED POLYOLS” which is herein incorporated by reference.

### FIELD OF THE INVENTION

Embodiments of the invention relate to a composite article of a bound particulate substance; a method of its fabrication employing as binder an elastomer made using natural oil based polyols.

### BACKGROUND OF THE INVENTION

Polyurethanes are often used as binders or adhesives in the production of composite products from, for example, organic particles of rubber, synthetic resin, wood or inorganic particles such as sand or quartz. Polyether polyols based on the polymerization of alkylene oxides, polyester polyols, or combinations thereof, are together with isocyanates the major components of a polyurethane system. Most commercially available polyols are produced from petroleum. However, the depletion of petroleum combined with its increasing price in our modern societies has encouraged researchers and governments to explore new ways to produce today's polymeric materials from renewable natural resources. Therefore, there is a need for a method of producing polyurethane binders or adhesives that result in an increased amount of renewable resources in the final composite products while maintaining the quality of the composite products.

### SUMMARY OF THE INVENTION

Embodiments of the invention provide for polyurethane binders or adhesives that result in an increased amount of renewable resources in the final composite products while yet maintaining the quality of the composite products.

In one embodiment, a composite article is provided which includes a particulate matter substantially coated with a cured adhesive composition, where the particulate matter includes an elastomeric rubber, reground foam material, or a particulate ligno-cellulosic substance, and the cured adhesive composition includes the reaction product of at least one first polyol composition and at least one prepolymer composition, where the prepolymer composition includes the reaction product of at least a second polyol composition and at least one isocyanate composition, and at least one of the first polyol composition and the second polyol composition includes at least one polyol derived from a natural oil.

In one embodiment, a method of forming a composite article is provided. The method includes providing at least a first polyol composition, forming at least one prepolymer composition by combing at least a second polyol composition with at least one isocyanate composition, reacting the at least first polyol composition with the at least one prepolymer composition in the presence of at least one particulate matter comprising an elastomeric rubber, reground foam material, or a particulate ligno-cellulosic substance. At least one of the first polyol composition and the second polyol composition includes at least one polyol derived from a natural oil.

In one embodiment, the particulate ligno-cellulosic substance comprises cork, wood, grass or straw.

In one embodiment, the at least one polyol derived from a natural oil comprises at least one of a hydroxymethylated fatty acid and a hydroxymethylated fatty acid ester.

In one embodiment, the at least one polyol derived from a natural oil comprises the reaction product of at least one of a hydroxymethylated fatty acid and a hydroxymethylated fatty acid ester and an initiator compound having a OH functionality, primary amine functionality, secondary amine functionality, or combination OH, primary, or secondary amine functionality, of between about 2 and about 4.

In one embodiment, the initiator compound is selected from ethylene glycol, 1,2- and 1,3-propylene glycol, 1,4- and 2,3-butane diol, 1,6-hexane diol, 1,8-octane diol, neopentyl glycol, cyclohexane dimethanol, 1,3-cyclohexane dimethanol and 1,4-cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and combinations thereof.

In one embodiment, the initiator compound comprises a mixture of 1,3-cyclohexane dimethanol and 1,4-cyclohexane dimethanol.

In one embodiment, the at least one polyol derived from a natural oil comprises at least an aliphatic polyester polyol prepared by the condensation of at least one diol and adipic, glutaric, succinic, dimer acid, or combination thereof. The at least one diol may be selected from 1,2- and 1,3-propylene glycol, 1,4- and 2,3-butane diol, 1,6-hexane diol, 1,8-octane diol, neopentyl glycol, cyclohexane dimethanol, 1,3-cyclohexane dimethanol and 1,4-cyclohexane dimethanol, 2-methyl-1,3-propane diol, and combinations thereof

In one embodiment, the at least one first polyol composition comprises the at least one polyol derived from a natural oil, and/or the at least one second polyol composition comprises the at least one polyol derived from a natural oil. The at least one second polyol composition may be the same as the at least one polyol derived from a natural oil of the first polyol composition.

### DESCRIPTION OF EMBODIMENTS OF THE INVENTION

Embodiments of the invention provide for a composite article with particular matter bound by elastomers made using natural oil based polyols and/or natural acid based polyols. The elastomer is a so-called two component elastomer, as it is made from reacting at least a first polyol composition with at least one prepolymer composition. The prepolymer composition may have at least one urethane group, and may be the reaction product of at least one isocyanate and at least a second polyol composition. The first polyol composition and the second polyol composition may be the same or different, with at least one, or both, of the first or second polyol compositions including at least one natural oil based polyol (NOBP).

Natural oil based polyols (NOBP) are polyols based on or derived from renewable feedstock resources such as natural plant vegetable seed oils. The renewable feedstock resources may also include genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Additionally, oils obtained from organisms such as algae may also be used. A combination of vegetable, algae, and animal based oils/fats may also be used.

For use in the production of polyurethane products, the natural material may be modified to give the material isocyanate reactive groups or to increase the number of isocyanate reactive groups on the material. Preferably such reactive groups are a hydroxyl group.

The modified natural oil derived polyols may be obtained by a multi-step process wherein vegetable oils/fats are subjected to transesterification and the constituent fatty acids recovered. This step is followed by hydroformylating carbon-carbon double bonds in the constituent fatty acids followed by reduction to form hydroxymethyl groups. Suitable hydroformylation/reduction methods are described in U.S. Pat. Nos. 4,731,486, 4,633,021, and 7,615,658, for example. The hydroxymethylated fatty acids or esters thereof are herein labeled “monomers” which form one of the building blocks for the natural oil based polyol. The monomers may be a single kind of hydroxymethylated fatty acid and/or hydroxymethylated fatty acid methyl ester, such as hydroxymethylated oleic acid or methylester thereof, hydroxymethylated linoleic acid or methylester thereof, hydroxymethylated linolenic acid or methylester thereof, α- and γ-linolenic acid or methyl ester thereof, myristoleic acid or methyl ester thereof, palmitoleic acid or methyl ester thereof, oleic acid or methyl ester thereof, vaccenic acid or methyl ester thereof, petroselinic acid or methyl ester thereof, gadoleic acid or methyl ester thereof, erucic acid or methyl ester thereof, nervonic acid or methyl ester thereof, stearidonic acid or methyl ester thereof, arachidonic acid or methyl ester thereof, timnodonic acid or methyl ester thereof, clupanodonic acid or methyl ester thereof, cervonic acid or methyl ester thereof, or hydroxymethylated ricinoleic acid or methylester thereof. In one embodiment, the monomer is hydroformulated methyloelate. Alternatively, the monomer may be the product of hydroformylating hydroformulating the mixture of fatty acids recovered from transesterifaction process of or vegetable oils/fats to form hydroxymethylated fatty acids or methyl esters thereof. In one embodiment the monomer is hydroxymethylated hydroformulated soy bean fatty acids or methyl esters thereof which may have an average OH functionality of between about 0.9 and about 1.1 per fatty acid, preferably, the functionality is about 1. In another embodiment the monomer is hydroformulated castor bean fatty acids. In another embodiment, the monomer may be a mixture of selected hydroxymethylated fatty acids or methylesters thereof.

A polyol is then formed by reacting the hydroxymethylated monomer with an appropriate initiator compound to form a polyester or polyether/polyester polyol. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil derived polyols may be any initiator used in the production of conventional petroleum-based polyols. Preferably the initiator is selected from the group consisting of neopentylglycol; 1,2-propylene glycol; trimethylolpropane; pentaerythritol; sorbitol; sucrose; glycerol; aminoalcohols such as ethanolamine, diethanolamine, and triethanolamine; alkanediols such as 1,6-hexanediol, 1,4-butanediol; 1,4-cyclohexane diol; 1,3-cyclohexanedimethanol, 1,4-cyclohexanedimethanol, 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. Preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. Preferably, the initiator is glycerol, trimethylopropane, pentaerythritol, sucrose, sorbitol, and/or mixture thereof.

Other initiators include other linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole.

In one embodiment, the initiators are alkoxlyated with ethylene oxide, propylene oxide, or a mixture of ethylene and at least one other alkylene oxide to give an alkoxylated initiator with a molecular weight between about 200 and about 6000, preferably between about 500 and about 5000. In one embodiment the initiator has a molecular weight of about 550, in another embodiment the molecular weight is about 625, and in yet another embodiment the initiator has a molecular weight of about 4600.

In one embodiment, at least one initiator is a polyether initiator having an equivalent weight of at least about 400 or an average at least about 9.5 ether groups per active hydrogen group, such initiators are described in copending Patent Application No. PCT/US09/37751, filed on Mar. 20, 2009, entitled “Polyether Natural Oil Polyols and Polymers Thereof” the entire contents of which are incorporated herein by reference.

The ether groups of the polyether initiator may be in poly(alkylene oxide) chains, such as in poly(propylene oxide) or poly(ethylene oxide) or a combination thereof. In one embodiment, the ether groups may be in a diblock structure of poly(propylene oxide) capped with poly(ethylene oxide).

In one embodiment, a NOPB is made with an initiator or combination of initiators having an average equivalent weight of between about 400 and about 3000 per active hydrogen group. All individual values and subranges between about 400 and about 3000 per active hydrogen group are included herein and disclosed herein; for example, the average equivalent weight can be from a lower limit of about 400, 450, 480, 500, 550, 600, 650, 700, 800, 900, 1000, 1200, or 1300 to an upper limit of about 1500, 1750, 2000, 2250, 2500, 2750, or 3000 per active hydrogen group.

Thus, in this embodiment, at least two of the natural oil based monomers are separated by a molecular structure having an average molecular weight of between about 1250 Daltons and about 6000 Daltons. All individual values and subranges between about 1250 Daltons and about 6000 Daltons are included herein and disclosed herein; for example, the average molecular weight can be from a lower limit of about 1250, 1500, 1750, 2000, 2250, 2500, 2750, 3000, or Daltons to an upper limit of about 3000, 3500, 4000, 4500, 5000, 5500, or 6000 Daltons.

To form the polyether initiator, the active hydrogen groups may be reacted with at least one alkylene oxide, such ethylene oxide or propylene oxide or a combination thereof; or a block of propylene oxide followed by a block of ethylene oxide, to form a polyether polyol by means within the skill in the art. The polyether initiator may be used as an initiator for reaction with at least one natural oil based monomer. Alternatively the initiator is reacted by means within the skill in the art to convert one or more hydroxyl groups to alternative active hydrogen groups, such as is propylene oxide.

Thus, in an embodiment, the natural oil based polyol may comprise at least two natural oil moieties separated by a molecular structure having at least about 19 ether groups or having an equivalent weight of at least about 400, preferably both. When the polyether initiator has more than 2 active hydrogen groups reactive with the natural oil or derivative thereof, each natural oil moiety is separated from another by an average of at least about 19 ether groups or a structure of molecular weight of at least about 400, preferably both.

The functionality of the resulting natural oil based polyols is above about 1.5 and generally not higher than about 6. In one embodiment, the functionality is below about 4. The hydroxyl number of the of the natural oil based polyols may be below about 300 mg KOH/g, preferably between about 50 and about 300, preferably between about 60 and about 200. In one embodiment, the hydroxyl number is below about 100.

The natural oil based polyols may alternatively be a polyester polyol produced from the condensation reaction of dimer fatty acids and non-dimer polycarboxilic acids with a polyhydroxy compound. Dimer fatty acids are known in the art, see for example, publication US 2005/0124711, the disclosure of which is incorporated herein by reference, and in general are dimerization products of mono- or polyunsaturated fatty acids and/or esters thereof. Such dimer fatty acids are dimers of C₁₀ to C₃₀, more preferably C₁₂ to C₂₄, and more preferably C₁₄ to C₂₂ alkyl chains. Suitable dimer fatty acids for producing the polyesters of the present invention include dimerization products of oleic acid, linoleic acid, linolenic acid, palmitoleic acid and elaidic acid. The dimerization products of the unsaturated fatty acid mixtures obtained in the hydrolysis of natural fats and oils, e.g. sunflower oil, soybean oil, olive oil, rapeseed oil, cottonseed oil and tall oil, may also be used.

Suitable non-dimer polycarboxylic acids can have two or more carboxylic acid groups or an equivalent number of anhydride groups on the basis that one anhydride group is equivalent to two acid groups. Such polycarboxylic acids are well known in the art. Preferably the polycarboxylic acid contains two carboxylic acid groups.

Examples of suitable polycarboxylic acids include aliphatic dicarboxylic acids having 2 to 12, preferably 2 to 8 carbon atoms in the alkylene radical. These acids include, for example, aliphatic dicarboxylic acids such as adipic acid, glutaric acid, pimelic acid, suberic acid, azelaic acid, sebacic acid, undecanedoic acid, dodecanadioic acid, succinic or hexanedioic acid; cycloaliphatic acids such as hexahydrophthalic acid and 1,3- and 1,4-cyclohexane dicarboxylic acid; 1,3- and 1,4-unsaturated alkane dioic acids such as fumaric or maleic acids; and aromatic acids such as phthalic acid and terephthalic. The anhydrides of the aforementioned polybasic acids such as maleic anhydride or phthalic anhydride can also be used. A combination of two or more of the polybasic acids may also be used. In one embodiment, it is preferred to use glutaric acid, succinic acid, adipic acid or a combination thereof. Such combination of acids are commercially available and generally comprise from 19 to 26 weight percent adipic acid, from 45-52 weight percent glutaric acid, and 16 to 24 weight percent succinic acid.

Examples of suitable polyhydroxy compounds are ethylene glycol, diethylene glycol, propylene glycol, dipropylene glycol, 1,3-propanediol, 1,10-decanediol, glycerine, trimethylolpropane, 1,4-butanediol, 1,6-hexanediol and 1,3-/1,4-cyclohexanedimethanol. If trifunctional or higher alcohols are used for the manufacture of the polyester polyols, for the production of elastomer for shoe soles, their amount is generally chosen in such that the functionality of a blend is a maximum of 2.8, preferably from 2 to 2.3. In one embodiment, ethylene glycol, diethylene glycol, butanediol, or a combination is used as an additional glycol component.

In addition to the dimer fatty acids, dimerisation usually results in varying amounts of oligomeric fatty acids, such as trimers, and residues of monomeric fatty acids, or esters thereof, being present. Commercially available products, such as those available from Uniqema, generally have a dicarboxylic (dimer) content of greater than 60% and up to greater than 95%. The trimer content is generally less than 40% and is preferably in the range of 2 to 25% for use in the present invention.

The polyester polyol preferably has a molecular weight number average in the range from 1,000 to 5,000, more preferably 1,700 to 3,000, particularly from 1,800 to 2,500 and more preferably from 1,900 to 2,200. The polyester preferably has a hydroxyl number from 10 to 100, preferably from 30 to 80 and more preferably from 40 to 70 mg KOH/g. In addition, the polyester generally has an acid value of less than 2, preferably less than 1.5, and more preferably less than 1.3.

Processes for the production of polyester polyols are well known in the art. To prepare the polyester polyols, the dimer and non-dimer poycarboxylic acids are polycondensed with polyhydroxy compounds. To remove volatile byproducts, the polyester polyols can be subjected to distillation under reduced pressure, stripping with an inert gas, vacuum, etc.

The at least a first polyol composition and the at least a second polyol composition may optionally include another kind of polyol, which includes at least one conventional petroleum-based polyol. Conventional petroleum-based polyols includes materials having at least one group containing an active hydrogen atom capable of undergoing reaction with an isocyanate, and not having parts of the material derived from a vegetable or animal oil. Suitable conventional petroleum-based polyols are well known in the art and include those described herein and any other commercially available polyol. Mixtures of one or more polyols and/or one or more polymer polyols may also be used to produce polyurethane products according to embodiments of the present invention.

Representative conventional petroleum-based polyols include polyether polyols, polyester polyols, polyhydroxy-terminated acetal resins, hydroxyl-terminated amines and polyamines. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound. The initiators suitable for the natural oil based polyols may also be suitable for the at least one conventional petroleum-based polyol.

The at least one conventional petroleum-based polyol may for example be poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide.

The polyether polyols may contain low terminal unsaturation (for example, less that 0.02 meq/g or less than 0.01 meq/g), such as those made using so-called double metal cyanide (DMC) catalysts. Polyester polyols typically contain about 2 hydroxyl groups per molecule and have an equivalent weight per hydroxyl group of about 400-1500.

The conventional petroleum-based polyols may be a polymer polyol. In a polymer polyol, polymer particles are dispersed in the conventional petroleum-based polyol. Such particles are widely known in the art an include styrene-acrylonitrile (SAN), acrylonitrile (ACN), polystyrene (PS), methacrylonitrile (MAN), or methyl methacrylate (MMA) particles. In one embodiment the polymer particles are SAN particles.

The conventional petroleum-based polyols may constitute up to about 10 weight %, 20 weight %, 30 weight %, 40 weight %, 50 weight %, or 60 weight % of polyol formulation. The conventional petroleum-based polyols may constitute at least about 1 weight %, 5 weight %, 10 weight %, 20 weight %, 30 weight %, or 50 weight % of polyol formulation.

The at least a first polyol composition and the at least a second polyol composition may optionally also include at least one chain extender. For purposes of the embodiments of the invention, a chain extender is a material having two isocyanate-reactive groups per molecule and an equivalent weight per isocyanate-reactive group of less than 400, preferably less than 300 and especially from 31-125 daltons. Representative of suitable chain-extending agents include polyhydric alcohols, aliphatic diamines including polyoxyalkylenediamines, and mixtures thereof. The isocyanate reactive groups are preferably hydroxyl, primary aliphatic amine or secondary aliphatic amine groups. The chain extenders may be aliphatic or cycloaliphatic, and are exemplified by triols, tetraols, diamines, triamines, aminoalcohols, and the like. Representative chain extenders include ethylene glycol, diethylene glycol, 1,3-propane diol, 1,3- or 1,4-butanediol, dipropylene glycol, 1,2- and 2,3-butylene glycol, 1,6-hexanediol, neopentylglycol, tripropylene glycol, 1,2-ethylhexyldiol, ethylene diamine, 1,4-butylenediamine, 1,6-hexamethylenediamine, 1,5-pentanediol, 1,6-hexanediol, 1,3-cyclohexandiol, 1,4-cyclohexanediol; 1,3-cyclohexane dimethanol, 1,4-cyclohexane dimethanol, N-methylethanolamine, N-methyliso-propylamine, 4-aminocyclohexanol, 1,2-diaminotheane, 1,3-diaminopropane, hexylmethylene diamine, methylene bis(aminocyclohexane), isophorone diamine, 1,3- or 1,4-bis(aminomethyl) cyclohexane, diethylenetriamine, and mixtures or blends thereof. The chain extenders may be used in an amount from about 0.5 to about 20, especially about 2 to about 16 parts by weight per 100 parts by weight of the polyol component.

In addition to the above described polyols, the polyol compositions may also include other ingredients such as catalysts, silicone surfactants, preservatives, and antioxidants.

The prepolymer composition may be made by reacting the at least one isocyanate and the at least second polyol composition. Suitable isocyanates for use in preparing the prepolyomer include a wide variety of organic mono- and polyisocyanates. Suitable monoisocyanates include benzyl isocyanate, toluene isocyanate, phenyl isocyanate and alkyl isocyanates in which the alkyl group contains from 1 to 12 carbon atoms. Suitable polyisocyanates include aromatic, cycloaliphatic and aliphatic isocyanates. Exemplary polyisocyanates include m-phenylene diisocyanate, toluene-2-4-diisocyanate, toluene-2-6-diisocyanate, isophorone diisocyanate, 1,3- and/or 1,4-bis(isocyanatomethyl)cyclohexane (including cis- or trans-isomers of either), hexamethylene-1,6-diisocyanate, tetramethylene-1,4-diisocyanate, cyclohexane-1,4-diisocyanate, hexahydrotoluene diisocyanate, methylene bis(cyclohexaneisocyanate) (H₁₂MDI), naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), toluene-2,4,6-triisocyanate and 4,4′-dimethyldiphenylmethane-2,2′,5,5′-tetraisocyanate. In some embodiments, the polyisocyanate is diphenylmethane-4,4′-diisocyanate, diphenylmethane-2,4′-diisocyanate, PMDI, toluene-2,4-diisocyanate, toluene-2,6-diisocyanate or mixtures thereof. Diphenylmethane-4,4′-diisocyanate, diphenylmethane-2,4′-diisocyanate and mixtures thereof are generically referred to as MDI, and all may be used. Toluene-2,4-diisocyanate, toluene-2,6-diisocyanate and mixtures thereof are generically referred to as TDI, and all may be used.

Derivatives of any of the foregoing isocyanate groups that contain biuret, urea, carbodiimide, allophonate and/or isocyanurate groups may also be used. These derivatives often have increased isocyanate functionalities and are desirably used when a more highly crosslinked product is desired.

The proportions of the isocyanate and the at least second polyol composition are chosen to provide an isocyanate terminated prepolymer product. This can be accomplished by using excess stoichiometric amount of polyisocyanate, that is, more than one isocyanate group per active hydrogen group, preferably hydroxyl, amine and unreacted carboxyl group of the at least second polyol composition. The ratio of isocyanate groups to active hydrogen, more preferably hydroxyl and amine groups, on the at least second polyol composition is preferably at least about 1.0, 1.2. 1.4, 1.5, 1.7, or 1.8, and independently preferably at most about 10, more preferably at most about 6, most preferably at most about 3. Higher (that is stoichiometric amounts or excess) isocyanate levels are optionally used.

Reaction of the at least second polyol composition with the polyisocyanate can be catalyzed using at least one catalyst within the skill in the art for such reactions. Examples of urethane catalysts include tertiary amines such as triethylamine, 1,4-diazabicyclo[2.2.2.]octane (DABCO), N-methylmorpholine, N-ethylmorpholine, N,N,N′,N′-tetramethylhexamethylenediamine, 1,2-dimethylimidazol; and tin compounds such as tin(II)acetate, tin(II)octanoate, tin(II)laurate, dibutyltin dilaurate, dibutyltin dimaleate, dioctyltin diacetate and dibutyltin dichloride. The catalysts are optionally used alone or as mixtures thereof. The reaction may be heated to temperatures between 20° C. and 100° C., and may take 2-6 hours to complete.

The first polyol composition and the prepolymer composition may then be used to form a composite product. The compositions of the first polyol composition and the second polyol composition of the prepolymer composition may be selected in numerous ways. For example, in one embodiment, all the polyols selected may be a NOBP, that is, the prepolymer may be made by reacting the isocyanate with only NOBPs, and that prepolymer may then be reacted with a polyol side where all the polyols are NOBPs, which may be the same or different NOBP than was used to make the prepolymer. In an alternative embodiment, one or both of the first or second polyol compositions may also include a conventional petroleum-based polyol, such as a polyether polyol. In certain embodiments, the NOBP used in the first polyol composition may be a NOBP made by reacting the hydroxymethylated monomers with a first initiator, and the second polyol composition may be a NOBP made by reacting the hydroxymethylated monomers with a second initiator. In one embodiment, the first initiator may be an alkoxylated initator having a functionality of between about 2 and about 4, and the second initator may be a cycloaliphatic diol (such as UNOXOL). Alternatively, the NOBPs used in the first polyol composition may be a mixture of the first initiator made NOBPs and the second initiator made NOBPs, and/or the NOBPs used in the second polyol composition may be a mixture of the first initiator made NOBPs and the second initiator made NOBPs.

In other embodiments, only one of the first and second polyol compositions may include a NOBP or a blend of different NOBPs.

In brief, a process for manufacturing a composite being a particulate matter substantially coated and bound together by a non-foamed polyurethane binder comprises a first step of intimately contacting the particulate matter with at least the first polyol composition and at least the prepolymer composition and a subsequent step of permitting the resulting mixture to cure to give the composite article. Alternatively, the first polyol composition and at least the prepolymer composition may first be mixed and the particular matter incorporated into the mix before the two component elastomer cures. The particulate matter may, for example, be an elastomeric rubber, reground foam material, inorganic particulate matter, or a particulate ligno-cellulosic substance such as cork, wood, grass or straw.

Ground rubber elastomeric composites useful in surfacings, sound absorbing materials, underlayers for recreational surfaces or other pavement or flooring can readily be prepared by coating the particulate matter, typically a ground vulcanized rubber with the polyurethane binder and bringing this mixture to a surface where it spread out and allowed to cure.

The urethane modified isocyanates of the present invention may also be used to prepare composites from inorganic particulate matter. For example, manufacture of artificial stone where quartz sand is bound using a polyurethane binder is disclosed in GB Patent 1,294,017.

Methods of manufacturing a mat with a textile surface, that can be composed of polypropylene fabric or tufted nylon or knitted polyester fabric or woven polyester; and an elastomer backing layer that includes elastomer crumbs, notably vulcanized rubber, and a polyurethane binder are disclosed in the following publications, incorporated herein by reference EP-A-1,518,668; EP-A-1511894; EP-A-1,511,893; and EP-1,549,797. In summary, such method involves mixing elastomer crumbs and a binder, depositing the crumb/binder mixture in a layer, placing a textile surface element on the layer to form a mat assembly, and pressing the mat assembly while setting the binder, so that the elastomer crumbs are consolidated to form an elastomer backing that includes voids between the elastomer crumbs, and the textile surface element is bonded to the elastomer backing.

### EXAMPLES

The following examples are provided to illustrate the embodiments of the invention, but are not intended to limit the scope thereof. All parts and percentages are by weight unless otherwise indicated.

The following materials were used:
VORANOL*EP 1900 A polyoxypropylene-oxyethylene diol (20 wt % oxyethylene) having an average molecular weight of 3800 and an OH number range of 26-29, available from The Dow Chemical Company.
Polyol B A bis-3-aminopropylmethylamine initiated polyoxypropylene polyol with a 17.5% polyoxyethylene cap polyol having an average molecular weight of 6800, an OH-number of about 33, and having a nominal functionality of 4.
1,4-Butanediol Available from International Specialty Products.
Dabco 33-S A 33 wt. % solution of triethylenediamine in 1,4-butanediol, available from Air Products and Chemicals, Inc.
Diethylene glycol Available from ME Global
FOMREZUL 38 A dioctyltin carboxylate catalyst available from Momentive Performance Materials Inc.
NOBP A NOBP A is a nominally 2.0-functional natural oil polyol prepared using hydroxymethylated fatty acid methyl ester monomers as described in U.S. Pat. No. 7,615,658. NOBP A is made by reacting the hydroxymethylated soybean fatty acid methyl ester monomers with an approximately 50/50% weight mixture of 1,3-cyclohexane dimethanol and 1,4-cyclohexane dimethanol (commercially available from The Dow Chemical Company under the trade designation Unoxol™), using 650 ppm stannous octoate (commercially available from City Chemical Co.) as the catalyst. NOBP-A has an average of approximately 2.0 hydroxyl groups/molecule, an OH number of 52.9, and number average molecular weight of about 2120.
VORALAST* GT 5000 A polyester diol made using ethylene glycol and di-ethylene glycol, adipic acid, glutaric acid, dimerized fatty acids, which has a nominal functionality of 2 and an OH number of about 56 and is available from The Dow Chemical Company.
VORALAST* GE 115 A prepolymer based on MDI and polyether diols and triols (NCO content of 18%), available from The Dow Chemical Company.
VORALAST* GE 143 A prepolymer based on MDI and polyether diols and triols (NCO content of 18%), available from The Dow Chemical Company.
ISONATE* M 125 A 4,4′-methylene diphenyl diisocyanate (Pure MDI) based isocyanate available from The Dow Chemical Company.
ISONATE* M 143 A liquified 4,4′-methylene diphenyl diisocyanate (Pure MDI) based isocyanate available from The Dow Chemical Company.
ISONATE* 50 OP A 50 percent 4,4′-methylene diphenyl isocyanate, 50 percent 2,4′-methylene diphenyl isocyanate mixture having a functionality of 2.0 and an equivalent weight of 125 g/equivalent available from The Dow Chemical Company.
Benzoyl Chloride Available from Moeller Chemie.
*ISONATE, VORALAST, and VORANOL are trademarks of The Dow Chemical Company.

The following test methods were used:
The hardness (Shore A) was measured according to ASTM D 2240, Test Method for Rubber Property—Durometer Hardness. The higher the value, the harder the elastomer.
Tensile Strength and Elongation at break (dry & wet) were measured according to DIN 53504 S2. The higher the value, the more tear resistant the elastomer.

All the examples (E1-E3) and both comparative examples (CE1 and CE2) were made by first mixing a Polyol mixture with a Prepolymer using a 2 component low pressure machine into a cup with cork granulate. The amounts of Polyol Mixture, Prepolymer, and cork used for all the examples and comparative examples are given in Table 1, as are the amounts of each component of the Polyol mixtures. For the Comparative Examples (CE1 and CE2) and Examples 1-3 (E1-E3), the Prepolymer is VORALAST GE 115 in the amounts given in Table 1.

In Example 4 (E4), the Prepolymer is an NOPB based prepolymer prepared by a controlled reaction of an excess of the isocyanates with the NOPB. A reaction vessel equipped with chemicals addition inlet, heating mantle, electrical stirrer, thermometer, and gas inlet and outlet for continuous flow of nitrogen, was charged with the isocyanate. The reaction was performed under by stirring of the isocyanate compounds and the benzoyl chloride, and feeding the NOPB into the reaction vessel at a controlled rate over about 2 hours, while maintaining the temperature in the vessel at about 60-75° C. After a total reaction time of about 3 hours, the isocyanate content was at the theoretical value. The Prepolymer was unloaded after stopping the reaction by cooling.

The Polyol Mixture, Prepolymer, and cork were mixed by hand for about 50 seconds until uniform and then pored into a 3 mm×200 mm×200 mm mold. The mold was closed after about 55-60 second. The demold time was about 10 minutes. Physical properties of the cured elastomer bound cork are found in Table 1.

TABLE 1

| | | CE1 | CE2 | E1 | E2* | E3 | E4 |
|---|---|---|---|---|---|---|---|
| Polyol mixture | VORANOL EP | 65.6 | 66.6 | 64.2 | 51.7 | 41.65 | 51.7 |
| (Parts) | 1900 | | | | | | |
| | Polyol B | 29.35 | 29.85 | 28.7 | 24.9 | 15 | 24.9 |
| | 1,4-Butanediol | 3 | 2 | 2 | 2 | 2 | 2 |
| | DABCO 33-S | 0.5 | 0.5 | 1 | 0.3 | 0.3 | 0.3 |
| | DEG | 1.5 | 1 | 1 | 1 | 1 | 1 |
| | FOMREZ UL 38 | 0.05 | 0.05 | 0.1 | 0.05 | 0.05 | 0.05 |
| | NOPB A | | | | 20 | 40 | 20 |
| | VORALAST* | | | 3 | | | |
| | GT 5000 | | | | | | |
| Prepolymer | VORALAST GE | 100 | 100 | 100 | 100 | 100 | |
| (Parts) | 115 | | | | | | |
| | ISONATE M | | | | | | 57.5 |
| | 125 | | | | | | |
| | ISONATE M | | | | | | 5 |
| | 143 | | | | | | |
| | NOPB A | | | | | | 37.5 |
| | Benzoyl Chloride | | | | | | 0.012 |

| | | | | | | |
|---|---|---|---|---|---|---|
| Amount polyol mixture (Grams) | 100 | 100 | 100 | 100 | 100 | 100 |
| Amount prepolymer (Grams) | 33 | 29 | 29 | 31.5 | 33 | 31.5 |
| Amount cork (Grams) | 15 | 15 | 15 | 15 | 12 | 15 |
| Hardness with cork, Shore A | 55 | 45 | 45 | 38/43 | 35 | 35 |
| Tensile strength with cork (N/mm²) | 1.1 | 1 | 1.3 | 1.2/1.0 | 0.85 | 1 |
| Elongation with cork (%) | 80 | 90 | 47 | 71/65 | 74 | 69 |

*Hardness, tensile strength, an elongation were measured at two separate locations for E2, and therefore both sets of results are reported.

As can be seen in Table 1 it is possible to incorporate polyols made from renewable resources into the binders and still get properties within the same range as binders made from only conventional petroleum-based polyols.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A composite article comprising:
a particulate matter substantially coated with a cured adhesive composition, wherein:
the particulate matter comprises an elastomeric rubber, reground foam material, or a particulate ligno-cellulosic substance; and
the cured adhesive composition comprises a reaction product of at least one first polyol composition and at least one prepolymer composition, wherein the prepolymer composition comprises the reaction product of at least a second polyol composition and at least one isocyanate composition, and at least one of the first polyol composition and the second polyol composition comprises at least one polyol derived from a natural oil.

2. A method of forming a composite article, the method comprising:
providing at least a first polyol composition;
forming at least one prepolymer composition by combing at least a second polyol composition with at least one isocyanate composition;
reacting the at least first polyol composition with the at least one prepolymer composition in the presence of at least one particulate matter comprising an elastomeric rubber, reground foam material, or a particulate ligno-cellulosic substance;
wherein at least one of the first polyol composition and the second polyol composition comprises at least one polyol derived from a natural oil.

3. The particulate matter of claim 1, wherein the particulate ligno-cellulosic substance comprises cork, wood, grass or straw.

4. The particulate matter of claim 1 3, wherein the particulate matter comprises cork.

5. The particulate matter of claim 1, wherein the at least one polyol derived from a natural oil comprises at least one of a hydroxymethylated fatty acid and a hydroxymethylated fatty acid ester.

6. The particulate matter of claim 5, wherein the at least one polyol derived from a natural oil comprises the reaction product of at least one of a hydroxymethylated fatty acid and a hydroxymethylated fatty acid ester and an initiator compound having a OH functionality, primary amine functionality, secondary amine functionality, or combination OH, primary, or secondary amine functionality, of between about 2 and about 4.

7. The particulate matter of claim 6, wherein the initiator compound is selected from ethylene glycol, 1,2- and 1,3-propylene glycol, 1,4- and 2,3-butane diol, 1,6-hexane diol, 1,8-octane diol, neopentyl glycol, cyclohexane dimethanol, 1,3-cyclohexane dimethanol and 1,4-cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and combinations thereof.

8. (canceled)

9. The particulate matter of claim 1, wherein the at least one polyol derived from a natural oil comprises at least an aliphatic polyester polyol prepared by the condensation of at least one diol and adipic, glutaric, succinic, dimer acid, or combination thereof and

10. wherein the at least one diol is selected from 1,2- and 1,3-propylene glycol, 1,4- and 2,3-butane diol, 1,6-hexane diol, 1,8-octane diol, neopentyl glycol, cyclohexane dimethanol, 1,3-cyclohexane dimethanol and 1,4-cyclohexane dimethanol, 2-methyl-1,3-propane diol, and combinations thereof

11. The particulate matter of claim 1, wherein the at least one first polyol composition comprises the at least one polyol derived from a natural oil and

12. the at least one second polyol composition comprises the at least one polyol derived from a natural oil.

13. The particulate matter of claim 9, wherein the at least one second polyol composition comprises at least one polyol derived from a natural oil, and which is the same as the at least one polyol derived from a natural oil of the first polyol composition.

14. The particulate matter of claim 10, wherein the at least one second polyol composition comprises at least one polyol derived from a natural oil, and which is different from the at least one polyol derived from a natural oil of the first polyol composition.

15. The method of claim 2, wherein the particulate ligno-cellulosic substance comprises cork, wood, grass or straw.

16. The method of claim 3, wherein the particulate matter comprises cork.

17. The method of claim 2, wherein the at least one polyol derived from a natural oil comprises at least one of a hydroxymethylated fatty acid and a hydroxymethylated fatty acid ester.

18. The method of claim 14, wherein the at least one polyol derived from a natural oil comprises the reaction product of at least one of a hydroxymethylated fatty acid and a hydroxymethylated fatty acid ester and an initiator compound having a OH functionality, primary amine functionality, secondary amine functionality, or combination OH, primary, or secondary amine functionality, of between about 2 and about 4.

19. The method of claim 15, wherein the initiator compound is selected from ethylene glycol, 1,2- and 1,3-propylene glycol, 1,4- and 2,3-butane diol, 1,6-hexane diol, 1,8-octane diol, neopentyl glycol, cyclohexane dimethanol, 1,3-cyclohexane dimethanol and 1,4-cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and combinations thereof.

20. The method of of claim 2, wherein the at least one polyol derived from a natural oil comprises at least an aliphatic polyester polyol prepared by the condensation of at least one diol and adipic, glutaric, succinic, dimer acid, or combination thereof and

21. wherein the at least one diol is selected from 1,2- and 1,3-propylene glycol, 1,4- and 2,3-butane diol, 1,6-hexane diol, 1,8-octane diol, neopentyl glycol, cyclohexane dimethanol, 1,3-cyclohexane dimethanol and 1,4-cyclohexane dimethanol, 2-methyl-1,3-propane diol, and combinations thereof

22. The method of claim 2, wherein the at least one first polyol composition comprises the at least one polyol derived from a natural oil and

23. wherein the at least one second polyol composition comprises the at least one polyol derived from a natural oil.

24. The method of claim 18, wherein the at least one second polyol composition comprises at least one polyol derived from a natural oil, and which is the same as the at least one polyol derived from a natural oil of the first polyol composition.

25. The method of claim 19, wherein the at least one second polyol composition comprises at least one polyol derived from a natural oil, and which is different from the at least one polyol derived from a natural oil of the first polyol composition.
